(19) United States
(12) Patent Application Publication
(10) Pub. No.: US 2025/0134312 A1
(43) Pub. Date: May 1, 2025

(54) COFFEE GRINDER CONTROL SYSTEM

(71) Applicant: Breville Pty Limited, Alexandria NSW (AU)

(72) Inventors: Ze Kang LAI, Alexandria NSW (AU); Lochana Subasekara WIDANAGAMAGE DON, Alexandria NSW (AU); Man Ho Kelvin LEE, Alexandria NSW (AU); Chunhuai WANG, Alexandria NSW (AU)

(21) Appl. No.: 18/684,104

(22) PCT Filed: Aug. 17, 2022
(86) PCT No.: PCT/AU22/50907

§ 371 Date: Feb. 15, 2024

(30) Foreign Application Priority Data
Aug. 17, 2021 (AU) 2021902561

(51) Int. Cl. A47J 42/44; A47J 42/46; A47J 42/50

(52) U.S. Cl. CPC A47J 42/44; A47J 42/46; A47J 42/50

(57) ABSTRACT

There is disclosed herein a control system for a coffee grinder, the coffee grinder comprising a hopper (320) for containing coffee beans from which ground coffee can be dispensed and a grinder motor (340) for grinding the coffee beans contained in the hopper (320), the control system including: a load sensor arrangement (380) for sensing at least one grinder motor running parameter during a grinding operation in which coffee beans in the hopper (320) is ground by the grinder motor (340) to provide ground coffee, the grinder motor (340) running parameter relating to a load experienced by the grinder motor (340) during the grinding operation; and a processor configured to determine, based at least on the grinder motor running parameter from the load sensor arrangement (380), an amount of ground coffee from the hopper (320) during the grinding operation.

### FIELD

The present invention relates to a coffee grinder control system.

### BACKGROUND

An example of a conventional control system for a coffee grinder operates the coffee grinder either over a run-time of the coffee grinder motor or over a number of revolutions of the grinder motor to provide a desired amount of ground coffee. This conventional control system typically implements a look-up table to correlate different ground coffee values for to a coffee grinder run-time or grinder motor revolutions. The user simply inputs the desired amount of ground coffee into the coffee grinder and the control system would determine, from the look-up table, the run-time or the number of revolutions of the grinder motor required for the desired amount of ground coffee. The control system would subsequently run the coffee grinder based on the determined run-time or the number of revolutions.

A drawback with this conventional control system is that the characteristics of the coffee beans (e.g. their brand, hardness, type, grind size) would inevitably impact the output of ground coffee beans from the grinder motor. In particular, operating the grinder motor over a predetermined run-time or revolutions for hard coffee beans would inevitably provide less ground coffee compared to operating the grinder motor over the same predetermined run-time or revolutions for soft coffee beans. Accordingly, relying on the run-time or the number of revolutions of the grinder motor would cause inaccuracies in the ground coffee output from the coffee grinder, which would affect the outcome of the subsequent coffee-making steps (e.g. tamping, brewing, etc.).

Another drawback of this conventional control system is that, if the coffee grinder is empty during operation or if it is blocked during operation, the user would need to manually determine the amount of ground coffee output by the coffee grinder thus far and set the remaining run-time or revolutions to provide the remaining ground coffee to reach the desired ground coffee. This manual process would inevitably also lead to further inaccuracies.

### SUMMARY

Preferred embodiments of the present invention seek to address at least one of the disadvantages described above and/or to at least provide the public with a useful choice.

An aspect of the present invention provides a control system for a coffee grinder, the coffee grinder comprising a hopper for containing coffee beans from which ground coffee can be dispensed and a grinder motor for grinding the coffee beans contained in the hopper, the control system including: a load sensor arrangement for sensing at least one grinder motor running parameter during a grinding operation in which coffee beans in the hopper is ground by the grinder motor to provide ground coffee, the grinder motor running parameter relating to a load experienced by the grinder motor during the grinding operation; a processor configured to determine, based at least on the grinder motor running parameter from the load sensor arrangement, an amount of ground coffee from the hopper during the grinding operation.

In one embodiment, the grinder motor running parameter includes an electrical current for driving the grinder motor during the grinding operation, and the load sensor arrangement includes an electrical sensor, such as a current sensor for measuring the electrical current for driving the grinder motor. In this embodiment, the processor may be configured to determine the amount of ground coffee from the hopper during the grinding operation based on the electrical current measured by the current sensor over a period of time. The period of time may be any one of at least 10 milliseconds, at least 50 milliseconds, at least 100 milliseconds, at least 500 milliseconds, at least 1 second, or at least 5 seconds.

In a further embodiment, the grinder motor running parameter includes an electrical power to the grinder motor during the grinding operation, and the load sensor arrangement includes an electrical sensor, such as a current sensor for measuring the electrical current for driving the grinder motor and/or a voltage sensor for measuring a voltage across the grinder motor. In this embodiment, the processor may be configured to determine the amount of ground coffee from the hopper during the grinding operation based on the measured electrical power to the grinder motor over a period of time. The period of time may be any one of at least 10 milliseconds, at least 50 milliseconds, at least 100 milliseconds, at least 500 milliseconds, at least 1 second, or at least 5 seconds.

In another embodiment, the grinder motor running parameter includes a speed of the grinder motor during the grinding operation, and the load sensor arrangement includes a speed sensor for measuring the motor speed of the grinder motor. In this embodiment, the processor is configured to determine the amount of ground coffee from the hopper during the grinding operation based on the speed measured by the speed sensor with respect to at least one rotation of the grinder motor. In another embodiment, the processor is configured to determine the amount of ground coffee from the hopper during the grinding operation based on the speed measured by the speed sensor with respect to a motor speed coefficient and a voltage coefficient.

In a further embodiment, the grinder motor running parameter includes a time for the grinder motor to complete a full or partial rotation during the grinding operation, and the load sensor arrangement includes a sensor for measuring a rotation of the grinder motor. In this embodiment, the processor is configured to determine the amount of ground coffee from the hopper during the grinding operation based on the time measured by the sensor with respect to the rotation of the grinder motor.

The sensor preferably includes a sensor component that is locatable on one of a dynamic portion or a static portion of the coffee grinder. The sensor preferably includes a reference component locatable on the other of the dynamic portion or static portion of the coffee grinder. The motor speed or time taken for the grinder motor to complete a full/partial rotation can be preferably determined in response to the sensor component detecting the reference component. For example, the motor speed or time may be determined when the reference component is aligned with, or within proximity of, the sensor component. In one example, the sensor component is located on the dynamic portion while the reference component is located on the static portion. In another example, the sensor component is located on the static portion while the reference component is located on the dynamic portion. In an example, the dynamic portion may be a rotatable head of the grinder motor or a rotatable shaft for driving the grinder motor. In an example, the static portion is a housing portion of the grinder motor near or adjacent to the dynamic portion.

In one embodiment, the sensor component may be a Hall effect sensor, and the reference component may be a magnet. The Hall effect sensor may be located on a housing of the grinder motor, while the magnet is located on a shaft for driving the grinder motor.

In another embodiment, the sensor component may be an optical switch or a photosensor, and the reference component may be an optical film.

The motor speed sensor may include a plurality of spaced apart sensor components and/or a plurality of spaced apart reference components for detecting a partial rotation of the grinder motor. In one example, the sensor may include one sensor component and two or more spaced apart reference components.

In an embodiment, the amount of ground coffee from the hopper during the grinding operation, is determined by the processor, over a grinding operation period; and the processor is preferably further configured to: determine an accumulated amount value of ground coffee based on a plurality of determined amounts of ground coffee during the grinding operation, each determined amount of ground coffee being in relation to a respective grinding operation period. The grinding operation period may be a time period or a rotation period. For example, the period may be any one of at least 10 milliseconds, at least 50 milliseconds, at least 100 milliseconds, at least 500 milliseconds, at least 1 second, or at least 5 seconds. Alternatively, the period may be one of a partial rotation of the grinder motor (e.g. one of a tenth, eighth, quarter, or half rotation of the motor), a full rotation of the grinder motor, or a plurality of rotations of the grinder motor. The accumulated amount value is preferably stored in computer memory that is accessible by the processor. The accumulated amount value may be updated, by the processor, as each subsequent amount of ground coffee during a grinding operation is determined.

The processor may be further configured to: receive a user input relating to a desired amount of ground coffee; discontinue the grinding operation when the accumulated amount value of ground coffee is determined to reach the desired amount of ground coffee. The coffee grinder may have an electronic selection system with which the user is able to provide the user input relating to the desired amount of ground coffee.

The processor is preferably further configured to: in response to determining that the grinder motor load is variable, continue updating the accumulated amount value of ground coffee. The processor may update the accumulated amount value of ground coffee with a respective amount of ground coffee upon completion of a grinding operation for that respective amount of ground coffee. The processor preferably continues updating the accumulated amount value of ground coffee at least until the accumulated amount value reaches the desired amount of ground coffee.

The processor may be further configured to: in response to determining that the grinder motor load is constant, discontinue the grinding operation and discontinue updating the accumulated amount value of ground coffee. In this example, the processor is further configured to display, on an electric display device of the coffee grinder, that the hopper is empty or blocked in response to determining that the grinder motor load is constant.

The processor may be further configured to: determine the amount of ground coffee from the hopper during the grinding operation in response to at least one characteristic of the coffee beans in the hopper.

An aspect of the present invention also provides a coffee grinder comprising: a hopper for containing coffee beans from which ground coffee can be dispensed; a grinder motor for grinding the coffee beans contained in the hopper; and the control system as previously described for determining an amount of ground coffee from the hopper during a grinding operation of the grinder motor, the control system being configured to control the grinder motor in response to the determined amount of ground coffee.

### BRIEF DESCRIPTION OF THE DRAWINGS

Embodiments of the invention will now be described, by way of non-limiting example, with reference to the accompanying drawings, in which:

FIG. 1 shows a flow chart outlining the steps performed by a processor according to an embodiment of the present invention;

FIG. 2 shows a flow chart outlining the steps performed by a processor according to an embodiment of the present invention; and

FIGS. 3A and 3B show a coffee grinder according to the present invention.

### DESCRIPTION OF EMBODIMENTS

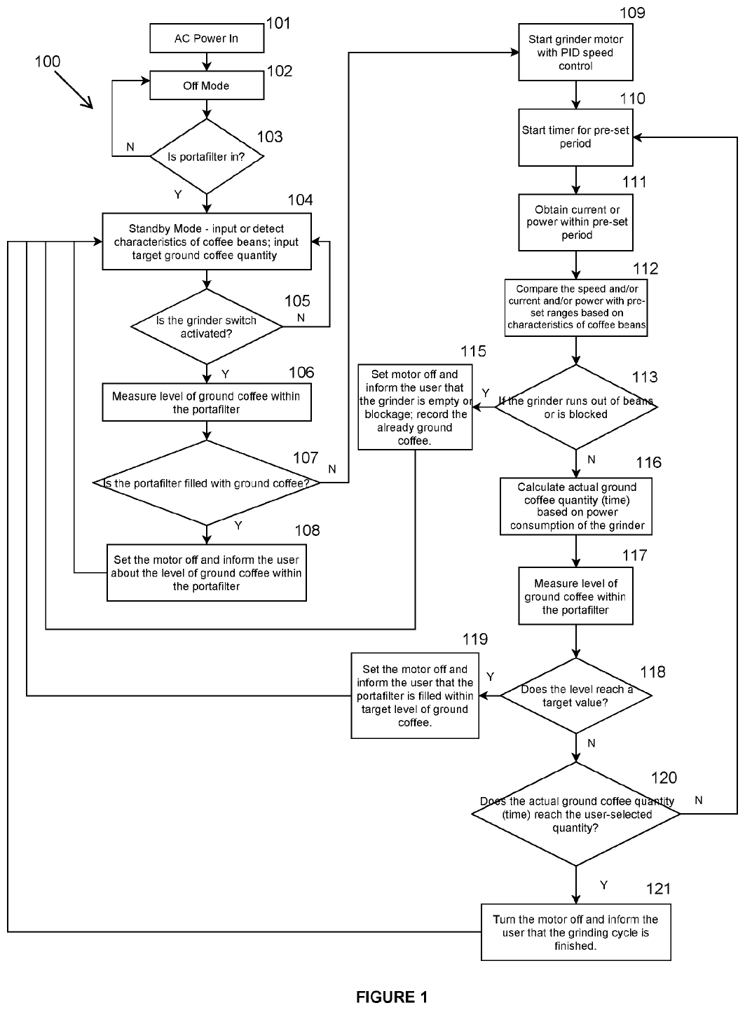

A control system for a coffee grinder according to an embodiment of the present invention implements the process shown in FIG. 1. The coffee grinder has a hopper for containing coffee beans from which ground coffee can be dispensed and a grinder motor for grinding the coffee beans contained in the hopper. The control system is configured to determine an amount of ground coffee from the hopper during a grinding operation of the grinder motor and to control the grinder motor in response to the determined amount of ground coffee. The ground coffee from the coffee grinder is provided to a portafilter. The portafilter in some embodiments may be located in a tamping mechanism that is configured to tamp the ground coffee in the portafilter once the desired amount of ground coffee is provided in the portafilter. The tamping mechanism may include an automatic auger tamp or a manual articulated tamp. For example, the tamping mechanism may be the tamping mechanism disclosed in WO 2012045112 Al (titled ‘TAMPING AUGER’ published on 12 Apr. 2012) and WO 2014165905 A1 (titled ‘IMPROVEMENTS TO COFFEE GRINDER’ published on 16 Oct. 2014).

The control system includes a processor that is configured to control the operation of the coffee grinder. The processor may be a microcontroller.

The control system includes an electronic user input device at which a user can input the desired ground coffee amount and/or the desired fineness for the ground coffee. The electronic user input device may be a display screen for example. Based on the user's input on the ground coffee amount and/or fineness, the control system can determine, from one or more look-up tables, a total amount of time needed for the grinder motor to operate in grinding operation to provide the desired amount/fineness of ground coffee. The total amount of time may be displayed on the display screen and is updated as the grinder motor operates to grind the coffee beans in the hopper.

The coffee grinder includes a load sensor arrangement for sensing at least one grinder motor running parameter during a grinding operation in which coffee beans in the hopper is ground by the grinder motor to provide ground coffee. The grinder motor running parameter relates to a load experienced by the grinder motor during the grinding operation. In particular, the grinder motor running parameter relates to a grinding resistance or grinding friction experienced by the grinder motor during a grinding operation, which would account for the coffee bean characteristics (hardness of the coffee bean and fineness of ground coffee). For example, a hard coffee bean would create more resistance/friction to the grinding operation while a soft coffee bean would create less resistance/friction to the grinding operation. The resistance/friction experienced by the grinder motor can be detected from the electrical current drawn by the motor during a grinding operation, the electrical power to the motor during the grinding operation, and/or a revolution of the grinder motor (e.g. the time is takes the grinder motor to complete a partial/full rotation or the grinder motor speed).

For the process 100 shown in FIG. 1, the load sensor arrangement is a current sensor for measuring an electrical current for driving the grinder motor during the grinding operation. The grinder motor would draw more electrical current when grinding a hard coffee bean and would draw less electrical current when grinding a soft coffee bean. Accordingly, from the electrical current, the processor is able to determine a load experienced by the grinder motor. The processor is configured to determine the amount of ground coffee from the hopper during the grinding operation based on the electrical current measured by the current sensor over a period of time. The period of time may be any one of at least 10 milliseconds, at least 50 milliseconds, at least 100 milliseconds, at least 500 milliseconds, at least 1 second, or at least 5 seconds. Alternatively, the period may be a full or partial revolution of the grinder motor. A shorter period of time for the electrical current measurement would provide a higher degree of accuracy on the ground coffee from the coffee grinder.

With reference to FIG. 1, the process 100 implemented by the control system begins once the coffee grinder is powered up (step 101). The control system keeps the coffee grinder in an off-mode (step 102) in which the coffee grinder is not performing a grinding operation until the control system detects a portafilter being located at a ground coffee grinder outlet of the coffee grinder (step 103). This step (step 103) is an additional or optional step for machines that have a detection system for detecting a portafilter. Once the portafilter is detected to be present, the control system transitions the coffee grinder to a standby mode (step 104) in which the coffee grinder receives input relating to, or detects, the characteristics of the coffee beans and also receives a user input on a desired (or target) amount of ground coffee. The user could also set the desired fineness for the ground coffee beans. In this regard, the control system has computer memory for storing one or more look-up tables containing information relating to a variety of coffee bean profiles and their characteristics (including the grinder motor running parameter previously described) and has a display screen on which the user can select the coffee beans that have been inserted in the hopper.

The coffee grinder includes a switch that is operable to activate the grinding operation (step 105) once the desired coffee amount has been input by the user into the coffee grinder. The coffee grinder has a portafilter sensor for measuring a level of the ground coffee in the portafilter and the control system is configured to determine the level of ground coffee within the portafilter based on measurements from the portafilter sensor (step 106). This step (step 106) is an additional or optional step for machines that have a tamping mechanism for tamping the ground coffee in the portafilter. The amount of ground coffee in the portafilter can be determined by measuring an auger motor current of the tamping mechanism for tamping the coffee in the portafilter or using a sensor of the tamping mechanism. If an amount of ground coffee in the portafilter is at the desired amount of ground coffee (step 107), the control system would deactivate the grinder motor and notify the user, e.g. on the display screen, that the desired ground coffee in the portafilter has been reached (step 108). On the other hand, if an amount of ground coffee in the portafilter is below the desired amount of coffee, the control system would activate the grinder motor in a grinding operation to grind the coffee beans container in the hopper (step 109). The control system implements a proportional-integral-derivative (PID) control to operate the grinder motor in a grinding operation.

The control system starts a timer for a pre-set period (step 110). This period is a period during which a grinding operation is performed. As previously mentioned, the period may be any one of at least 10 milliseconds, at least 50 milliseconds, at least 100 milliseconds, at least 500 milliseconds, at least 1 second, or at least 5 seconds. In another example, the period may be a full or partial revolution (or turn) of the grinder motor. A shorter period would provide a higher degree of accuracy on the ground coffee from the coffee grinder. The coffee grinder system includes a current sensor for measuring an electrical current for driving the grinder motor. The control system is configured to determine the electrical current, as measured by the current sensor, during this period of time (step 111). The electrical current determined during this period of time is compared with a corresponding value from the look-up table (step 112) from which the ground coffee amount during that pre-set period can be determined.

In one example, the look-up table maps, for different coffee bean characteristics, the electrical current values to ground coffee amounts. The control system is configured to update a total ground coffee value based on the determined ground coffee amount corresponding to each measured electrical current value over a period of time. The grinder motor is operated until the total ground coffee value reaches the desired ground coffee value. The look-up table according to this example is shown below.

| | Measured electrical | |
|---|---|---|
| Coffee bean | current during a | Ground coffee |
| characteristic | pre-set period | amount |
| θ₁ | I₁₁ . . . I₁ₙ | Q₁₁ . . . Q₁ₙ |
| θ₂ | I₂₁ . . . I₂ₙ | Q₂₁ . . . Q₂ₙ |
| . . . | . . . | . . . |
| θₘ | Iₘ₁ . . . Iₘₙ | Qₘ₁ . . . Qₘₙ |

where m and n are integers greater than zero, θₘ is a respective coffee bean characteristic, Iₘₙ is an electrical current value corresponding to a coffee bean characteristic of θₘ, and Qₘₙ is a ground coffee quantity amount mapped to Iₘₙ. The total ground coffee value Q_{T} is a sum of the ground coffee amounts Qₘₙ(i) during an operation of the grinder motor over i^{th} pre-set periods of time until the total ground coffee value Q_{T} reaches the desired ground coffee amount Q_{D}, based on the formula shown below. The total ground coffee value is updated stored in computer memory following each iteration.

$${Q}_{T} = {\sum }_{i = 0}^{i : {Q}_{T} = {Q}_{D}} {Q}_{mn} ( i )$$

In another example, the look-up table maps different coffee bean characteristics to grinder motor current coefficients. In this regard, the current drawn by the motor to grind two identical amounts of different coffee beans would vary depending on the coffee bean characteristics. For example, a harder bean would require the grinder motor to draw more current for the grinding operation, while a softer bean would require the grinder motor to draw less current for the grinding operation under the same voltage. The grinder motor current coefficient Cᵢ seeks to compensate for a bean characteristic with respect to a measured electrical current value or both the measured electrical current value and voltage value in the determination of the ground coffee quantity. During an i^{th} pre-set period of time t, once the coefficient Cᵢ is known, an electrical energy consumption Eᵢ of the grinder motor during that pre-set period of time can be estimated based on the voltage Vi across the motor, the electrical current Iᵢ drawn by the motor, and the grinder motor current coefficient Ci. The ground coffee amount Qᵢ during the pre-set period can subsequently be determined from another look up table that maps the energy consumption values to ground coffee values. The look-up tables and the total ground coffee value calculations according to this example are shown below. According to the first look-up table below, the system assumes that the coefficient Cᵢ would be constant across different drawn electrical currents for the same coffee bean characteristic. In a variation, the first look up table may include a column for electrical current drawn by the motor, each coffee bean characteristic value being associated with a range or a plurality of electrical current values. In this variation, the coefficients with respect to a coffee bean characteristic would vary depending on the electrical current drawn by the motor. That is, in this variation, the system assumes that the coefficient Cᵢ may vary across different drawn electrical currents for the same coffee bean characteristic. The coefficients are determined during the manufacturing stage and preprogrammed into the system.

| | Grinder motor |
|---|---|
| Coffee bean | current coefficient |
| characteristic | (or current and voltage) |
| θ₁ | C₁ |
| θ₂ | C₂ |
| . . . | . . . |
| θₘ | Cₘ |

The electrical energy consumption value during the pre-set period t:

$${E}_{i} = {V}_{i} {C}_{i} {I}_{i} t$$

| Electric energy | Ground coffee |
|---|---|
| consumption | amount |
| E₁ | Q₁ |
| E₂ | Q₂ |
| . . . | . . . |
| Eₘ | Qₘ |

The total ground coffee value Q_{T} is a sum of the ground coffee amounts Qᵢ during an operation of the grinder motor over an i^{th} pre-set period of time until the total ground coffee value Q_{T} reaches the desired ground coffee amount Q_{D}. The total ground coffee value is updated stored in computer memory following each iteration.

$${Q}_{T} = {\sum }_{i = 0}^{i : {Q}_{T} = {Q}_{D}} {Q}_{i}$$

A constant electrical current over a period of time or a no-load electrical current (e.g. an electrical current indicative of no resistance experienced by the grinder motor) for a period of time is indicative of the hopper being empty or a blockage in the coffee grinder. In particular, a constant electrical current or a no-load electrical current would indicate that the motor is running at a constant speed and not experiencing any resistance/load/friction which would be the case for an empty hopper or a blockage. If the control system determines that the coffee grinder is out of beans or there is blockage (step 113), the control system deactivates the grinder motor and is configured to notify the user, e.g. on the display screen, that the coffee grinder is empty or blocked (step 115). In addition, an accumulated amount value of ground coffee is stored in computer memory such that when the coffee grinder is refilled with coffee beans or is unblocked, the control system will pick up where it left of previously from the stored accumulated amount value. Thereafter, the coffee grinder returns to its standby mode (step 104). On the other hand, if the coffee grinder is determined by the processor to not be empty or blocked, then the control system is configured to calculate the ground coffee produced during the pre-set period based on the electrical current drawn by the grinder motor during that period of time (step 116). The amount of ground coffee that is produced during this pre-set period is added to the accumulated amount value of ground coffee that is stored in computer memory. The ground coffee that is produced during this pre-set period in is provided to the portafilter. The time remaining to reach the desired ground coffee amount can be updated accumulated amount value of ground coffee during the pre-set period of time.

The control system is configured to subsequently determine the level of ground coffee in the portafilter (step 117). This step (step 117) is an additional or optional step for machines that have a tamping mechanism for tamping the ground coffee in the portafilter. If the measured level of ground coffee in the portafilter reaches the desired ground coffee amount, the control system deactivates the motor and notifies the user, e.g. on the display screen of the coffee grinder, that the desired amount of ground coffee is available in the portafilter (step 119).

The control system is also configured to subsequently determine if the accumulated ground coffee value has is equal to the desired ground coffee value (step 120). If the accumulated ground coffee value reaches the desired ground coffee amount, the control system deactivates the motor and notifies the user, e.g. on the display screen of the coffee grinder, that the desired amount of ground coffee is available in the portafilter (step 121). Otherwise, the control system runs the grinder motor for another pre-set period (step 110).

As a variation or an extension to the example described with reference to FIG. 1, the control system may be configured to determine the amount of ground coffee during a grinding operation of the grinder motor based on a power consumption of the grinder motor or based on a consumed electrical energy value. In this example, the control system is configured to receive voltage measurements indicative of a voltage across the grinder motor and an electrical current drawn by the grinder motor. From a look-up table, the control system is configured to determine a motor grinder electrical coefficient corresponding to the characteristics of the coffee bean to compensate for variations in power consumption in response to coffee bean coffee bean characteristics. The electrical coefficient may be the grinder motor current coefficient previously described above. Thereby, the power consumption can be determined as a product of the voltage across the grinder motor, the electrical current drawn by the grinder motor, and the electrical coefficient. The amount of ground coffee can be subsequently determined by the control system from a look-up table that maps different power consumption values to ground coffee amount values. In this example, a constant power consumption over a period of time would be indicative of the hopper being empty or a blockage in the coffee grinder.

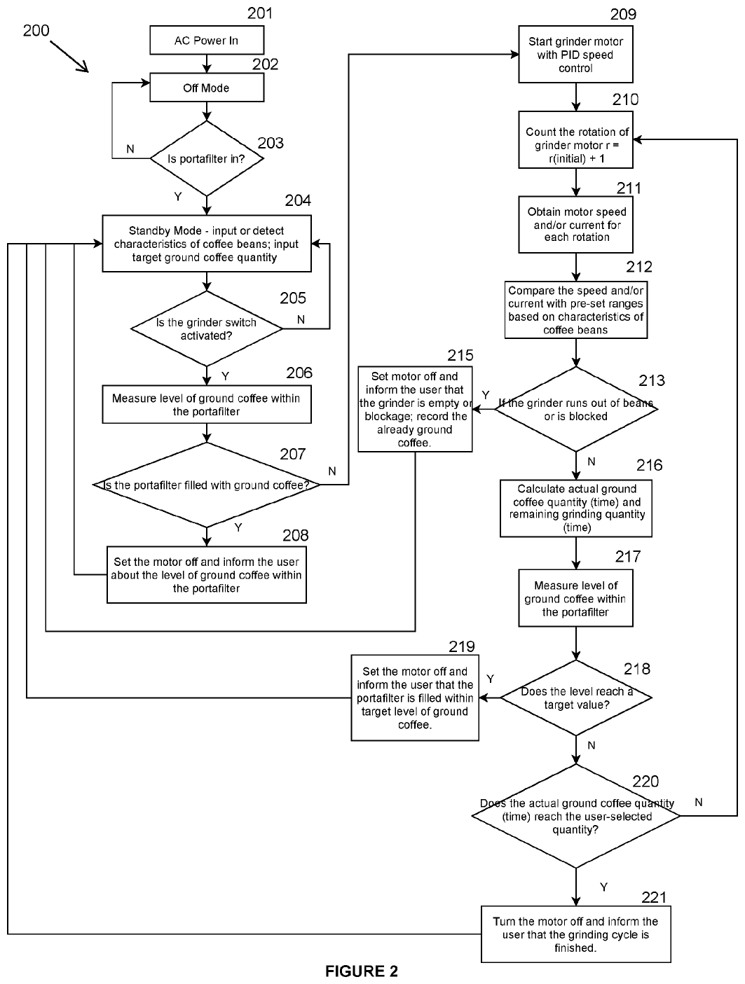

For the process 200 shown in FIG. 2, the load sensor arrangement is a motor sensor for measuring a rotation of the grinder motor during the grinding operation. The grinder motor would complete a revolution slower when grinding a hard coffee bean and would complete a revolution faster when grinding a soft coffee bean. Accordingly, from the detected revolution times, the processor is able to determine a load experienced by the grinder motor. The processor is configured to determine the amount of ground coffee from the hopper during the grinding operation based on the revolutions measured by the motor sensor with respect to a revolution. The period may be one of a partial rotation of the grinder motor (e.g. one of a tenth, eighth, quarter, or half rotation of the motor), a full rotation of the grinder motor, or a plurality of rotations of the grinder motor.

With reference to FIG. 2, the process 200 implemented by the control system begins once the coffee grinder is powered up (step 201). The control system keeps the coffee grinder in an off-mode (step 202) in which the coffee grinder is not performing a grinding operation until the control system detects a portafilter being located at a ground coffee grinder outlet of the coffee grinder (step 203). This step (step 203) is an additional or optional step for machines that have a detection system for detecting a portafilter. Once the portafilter is detected to be present, the control system transitions the coffee grinder to a standby mode (step 204) in which the coffee grinder receives input relating to, or detects, the characteristics of the coffee beans and also receives a user input on a desired (or target) amount of ground coffee. The user could also set the desired fineness for the ground coffee beans. In this regard, the control system has computer memory for storing one or more look-up tables containing information relating to a variety of coffee bean profiles and their characteristics (including the grinder motor running parameter previously described) and has a display screen on which the user can select the coffee beans that have been inserted in the hopper.

The coffee grinder includes a switch that is operable to activate the grinding operation (step 205) once the desired coffee amount has been input by the user into the coffee grinder. The coffee grinder has a portafilter sensor for measuring a level of the ground coffee in the portafilter and the control system is configured to determine the level of ground coffee within the portafilter based on measurements from the portafilter sensor (step 206). This step (step 206) is an additional or optional step for machines that have a tamping mechanism for tamping the ground coffee in the portafilter. The amount of ground coffee in the portafilter can be determined by measuring an auger motor current of the tamping mechanism for tamping the coffee in the portafilter or using a sensor of the tamping mechanism. If an amount of ground coffee in the portafilter is at the desired amount of ground coffee (step 207), the control system would deactivate the grinder motor and notify the user, e.g. on the display screen, that the desired ground coffee in the portafilter has been reached (step 208). On the other hand, if an amount of ground coffee in the portafilter is below the desired amount of coffee, the control system would activate the grinder motor in a grinding operation to grind the coffee beans container in the hopper (step 209). The control system implements a proportional-integral-derivative (PID) control to operate the grinder motor in a grinding operation.

In one example, the look-up table maps, for different coffee bean characteristics, motor speed values of the grinder motor (which may related to a motor speed coefficient Cm and/or a voltage speed coefficient C_{vi-I} as described below) to ground coffee amounts. In this regard, it is understood that a number of factors can impact motor speed, including the following: a) Individual motor torque under the same voltage or the same load or the same coffee beans (the higher the torque, the higher the speed); b) Supply voltage under the same load or the same coffee beans (the higher voltage, the higher the speed); c) Coffee bean hardness (the softer the coffee beans, the higher the speed). To compensate for motor torque differences in variations of speed, each individual motor may be tested for its torque value against a standard motor. Based on the motor torque value difference, a speed coefficient value (i.e. motor speed coefficient Cₘ) can be nominated for the tested motor. To compensate for voltage differences in variations of speed, the supply voltage range may be divided into small portions n. Each portion n is then tested for speed differences under a standard load, and a voltage speed coefficient Cvi−i from 1 to n may be generated.

To determine the actual grinder motor speed, the processor is configured to monitor a (full or partial) revolution or revolutions of the grinder motor and monitor the time taken by the grinder motor to complete the revolution(s). This determined actual motor speed value is then compared to the grinder motor values in look-up table to determine the corresponding ground coffee amount value. For example, the look-up table maps the time taken for the grinder motor to complete a full/partial revolution to ground coffee amounts. The control system is configured to update a total ground coffee value based on the determined ground coffee amount corresponding to each determined time value. The grinder motor is operated until the total ground coffee value reaches the desired ground coffee value. The look-up table according to this example is shown below. As another example, instead of mapping the time per revolution(s), the look-up table maps the grinder motor's revolutions per second (or revolutions per time) to a respective ground coffee amount value.

| | Measured time | |
|---|---|---|
| | value for grinder | |
| | motor to complete | |
| Coffee bean | a full/partial | Ground coffee |
| characteristic | revolution | amount |
| θ₁ | t₁₁ . . . t₁ₙ | Q₁₁ . . . Q₁ₙ |
| θ₂ | t₂₁ . . . t₂ₙ | Q₂₁ . . . Q₂ₙ |
| . . . | . . . | . . . |
| θₘ | tₘ₁ . . . tₘₙ | Qₘ₁ . . . Qₘₙ |

where m and n are integers greater than zero, θₘ is a respective coffee bean characteristic, Iₘₙ is an electrical current value corresponding to a coffee bean characteristic of θₘ and Qₘₙ is a ground coffee quantity amount mapped to Iₘₙ. In another example, the look-up table above may map measured grinder motor speed values to ground coffee amount values. The total ground coffee value Q_{T} is a sum of the ground coffee amounts Qₘₙ(i) during an operation of the grinder motor over an i^{th} pre-set period of time until the total ground coffee value Q_{T} reaches the desired ground coffee amount Q_{D}. The total ground coffee value is updated stored in computer memory following each iteration.

$${Q}_{T} = {\sum }_{i = 0}^{i : {Q}_{T} = {Q}_{D}} {Q}_{mn} ( i )$$

In another example, the look-up table maps, different coffee bean characteristics or grinder motor operation characteristics to respective coefficients. The coefficients seek to compensate for the coffee bean characteristics in the determination of the ground coffee quantity. By way of example, the coefficients may include a coefficient based on a measured electrical current drawn by the grinder motor and/or a coefficient based on a time taken by the grinder motor to complete a full revolution or a partial revolution. The coefficients are a percentage value such that an adjustment value can be determined based on a ground coffee value, determined from a main lookup table, and the coefficient. An estimated amount of ground coffee that is generated during a pre-set period would be a sum of the ground coffee value and the adjustment value(s).

By way of example, where the electrical current and time taken for the grinder motor to complete a full/partial revolution are to be taken into account, the computer memory stores a first coefficient look-up table that maps electrical current values to respective coefficient values and a second coefficient look-up table that maps time values to respective coefficient values. In this example, the computer memory also stores a main look-up table that maps the ground coffee values to a time taken for the grinder motor to complete a full/partial revolution and/or that maps the ground coffee values to electrical current values. The ground coffee values in the main look-up table are base (uncompensated) coffee amount values. The computer memory may store more than two coefficient look-up tables each based on a respective bean characteristic or grinder motor parameter/operation. For example, the computer memory may store a coefficient look-up table based on the grinder motor speed or a coefficient look-up table based on the electrical energy, power consumption of the grinder motor, a motor torque difference (e.g. a motor speed coefficient Cₘ as described above), and/or a voltage difference (e.g. a voltage speed coefficient Cvi−i from 1 to n as described above). The control system determines the electrical current drawn by the grinder motor using an electrical current sensor and the grinder motor operating time using a timer. Based on one or more of these values, the control system is configured to determine a base ground coffee value from a main look-up table and to determine the respective coefficients associated with those values from the coefficient look-up tables. The estimated amount of ground coffee can be subsequently determined by adding up the ground coffee value determined from the main look-up table and adjustment values based on the coefficients determined from the coefficient look-up tables. In a variation to this example, the main look-up table may store adjusted (compensated) ground coffee values that already incorporates the adjustment values with respect to the different time values and/or grinder motor speed values and/or electrical current values, such that the processor would be able to determine the ground coffee amount based on only one look-up table. In this variation, the separate coefficient look-up tables may not be provided. Alternatively, in this variation, separate coefficient look-up tables may be provided to map other parameters or characteristics of the coffee grinder of coffee beans, which are not covered by the main look-up table, to respective coefficient values. Subsequently, the processor is configured to determine the ground coffee amount based on the ground coffee value from the main look-up table and the coefficients from the coefficient look-up table(s).

A constant motor speed over a revolution or partial revolution and a motor speed that is above an average motor speed are indicative of the hopper being empty in the coffee grinder. In particular, a constant and high motor speed would indicate that the motor is not experiencing any resistance/load/friction which would be the case for an empty hopper. On the other hand, a significant reduction in motor speed is indicative of a blockage in the hopper. If the control system determines that the coffee grinder is out of beans or there is blockage (step 213), the control system deactivates the grinder motor and is configured to notify the user, e.g. on the display screen, that the coffee grinder is empty or blocked (step 215). In addition, an accumulated amount value of ground coffee is stored in computer memory such that when the coffee grinder is refilled with coffee beans or is unblocked, the control system will pick up where it left of previously from the stored accumulated amount value. Thereafter, the coffee grinder returns to its standby mode (step 204).

On the other hand, if the coffee grinder is determined by the processor to not be empty or blocked, then the control system is configured to calculate the ground coffee produced during the rotation or partial rotation based on the motor speed of the grinder motor (step 216). The amount of ground coffee that is produced over this rotation or partial rotation is added to the accumulated amount value of ground coffee that is stored in computer memory. The ground coffee that is produced over this rotation or partial rotation in is provided to the portafilter. The time remaining to reach the desired ground coffee amount can be updated using the following equation:

$$T = \frac{( M - m ) \times \frac{t}{n}}{\frac{m}{n}}$$

where
M is the desired amount of ground coffee; and
m is the ground coffee created during in an n rotation of the grinder motor within a period t

The control system is configured to subsequently determine the level of ground coffee in the portafilter (step 217). This step (step 217) is an additional or optional step for machines that have a tamping mechanism for tamping the ground coffee in the portafilter. If the measured level of ground coffee in the portafilter reaches the desired ground coffee amount, the control system deactivates the motor and notifies the user, e.g. on the display screen of the coffee grinder, that the desired amount of ground coffee is available in the portafilter (step 219).

The control system is also configured to subsequently determine if the accumulated ground coffee value has is equal to the desired ground coffee value (step 120). If the accumulated ground coffee value reaches the desired ground coffee amount, the control system deactivates the motor and notifies the user, e.g. on the display screen of the coffee grinder, that the desired amount of ground coffee is available in the portafilter (step 221). Otherwise, the control system runs the grinder motor over another rotation or partial rotation (step 210).

In another embodiment, the control system can be configured to determine an amount of ground coffee from a coffee grinder based on a combination of two or more of the electrical current drawn by the grinder motor, power consumption of the grinder motor, and on the grinder motor speed. The steps implemented by the control system according to these other embodiment would be similar to, and a combination of, the steps previously described with reference to FIGS. 1 and 2.

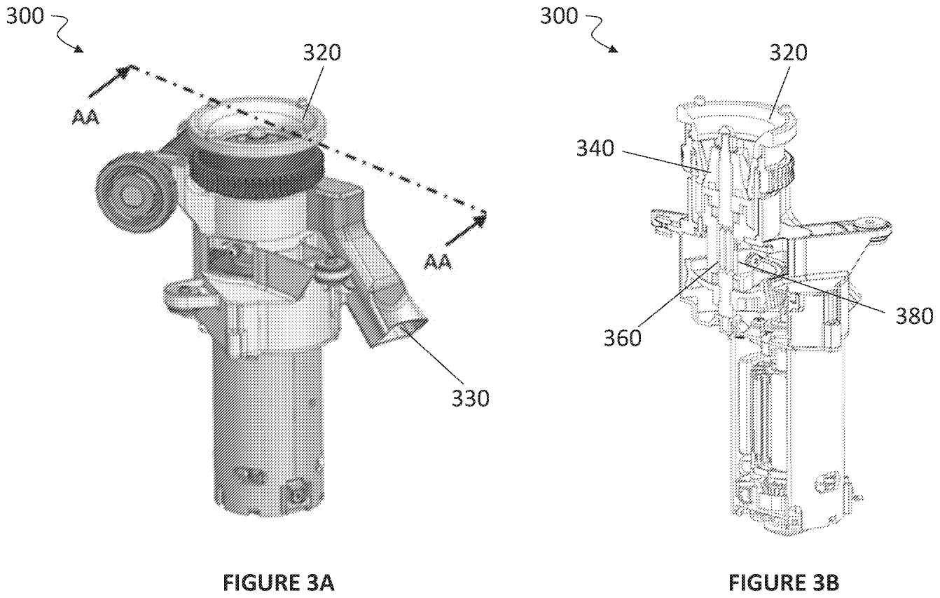

FIGS. 3A and 3B show a coffee grinder according to an embodiment of the present invention. The coffee grinder has a hopper 320 for containing coffee beans to be ground and a grinder motor (or inner burr gear) 340 for grinding the coffee beans in the hopper. The coffee grinder includes an outlet channel 330 from which the ground coffee that is created from the grinding gear grinding the coffee beans in the hopper can be provided to a portafilter.

The motor speed sensor for the coffee grinder has a sensor component 380 that is located on a static portion of the coffee grinder and reference components 360 located on the dynamic portion of the coffee grinder, being a portion of the motor. The sensor component 380 on the static portion of the coffee grinder is provided in proximity of the dynamic portion. The reference components rotate with the grinder motor with respect to the sensor component such that the sensor component is able to detect the reference component when the reference component is in proximity of the sensor component. The motor speed can subsequently be determined in response to the sensor component detecting the reference component. In another example, the sensor component may be located on the dynamic portion of the coffee grinder while the reference component(s) may be located on the static portion of the coffee grinder.

In the example shown in FIGS. 3A and 3B, the dynamic portion component on which the reference components 360 are located is a rotatable shaft for driving the grinder motor 340. The static portion on which the sensor component is provided is a housing portion of the grinder motor, near or adjacent to the dynamic portion, which houses the rotatable shaft. The sensor component 380 is a Hall effect sensor for detecting a magnetic field and the reference components 360 are magnets. The magnets 380 are spaced apart from each outer about a rotation axis of the shaft. In particular, the magnets are positioned on opposite sides of the rotation shaft, separated from each other by 180°. Using two magnets allows for a half rotation of the grinder motor to be detected. In another example, only one magnet may be provided for which a full rotation can be detected. In yet other examples, more than two magnets may be provided on the shaft or dynamic portion of the coffee grinder.

In another embodiment, the motor sensor may include an optical switch or a photosensor as the sensor component and an optical film as the reference component. The optical switch in this embodiment is configured to provide an output when the reference component is in the line of sight of the optical switch. In particular, a line of sight between the sensor component and the reference component would be created as the grinder motor rotates. The motor speed can subsequently be determined based on the outputs provided by the optical switch.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

1. A control system for a coffee grinder, the coffee grinder comprising a hopper for containing coffee beans from which ground coffee can be dispensed and a grinder motor for grinding the coffee beans contained in the hopper, the control system including:
a load sensor arrangement for sensing at least one grinder motor running parameter during a grinding operation in which coffee beans in the hopper is ground by the grinder motor to provide ground coffee, the grinder motor running parameter relating to a load experienced by the grinder motor during the grinding operation; and
a processor configured to determine, based at least on the grinder motor running parameter from the load sensor arrangement, an amount of ground coffee from the hopper during the grinding operation.

2. The control system according to claim 1,
wherein the grinder motor running parameter includes an electrical current or an electrical power for driving the grinder motor during the grinding operation, and the load sensor arrangement includes an electrical sensor for measuring the electrical current for driving the grinder motor; and
wherein the processor is configured to determine the amount of ground coffee from the hopper during the grinding operation based on an electrical current or electrical power measured by the electrical sensor over a period of time.

3. The control system according to claim 1,
wherein the grinder motor running parameter includes a motor speed of the grinder motor during the grinding operation, and the load sensor arrangement includes a speed sensor for measuring the motor speed of the grinder motor; and
wherein the processor is configured to determine the amount of ground coffee from the hopper during the grinding operation based on the speed measured by the speed sensor with respect to at least one rotation of the grinder motor.

4. The control system according to claim 1,
wherein the grinder motor running parameter includes a motor speed of the grinder motor during the grinding operation, and the load sensor arrangement includes a speed sensor for measuring the motor speed of the grinder motor; and
wherein the processor is configured to determine the amount of ground coffee from the hopper during the grinding operation based on the speed measured by the speed sensor with respect to a motor speed coefficient and a voltage coefficient.

5. The control system according to claim 1,
wherein the grinder motor running parameter includes a time for the grinder motor to complete a full or partial rotation during the grinding operation, and the load sensor arrangement includes a sensor for measuring a rotation of the grinder motor; and
wherein the processor is configured to determine the amount of ground coffee from the hopper during the grinding operation based on the time measured by the sensor with respect to the rotation of the grinder motor.

6. The control system according to claim 3, wherein the speed sensor includes a sensor component that is locatable on one of a dynamic portion or a static portion of the coffee grinder and a reference component locatable on the other of the dynamic portion or static portion of the coffee grinder, wherein the motor speed or time can be determined in response to the sensor component detecting the reference component.

7. The control system according to claim 6, wherein the sensor component is a Hall effect sensor, and the reference component is a magnet.

8. The control system according to claim 6, wherein the sensor component is an optical switch or a photosensor, and the reference component is an optical film.

9. The control system according to claim 6, wherein the speed sensor includes a plurality of spaced apart sensor components and/or a plurality of spaced apart reference components for detecting a partial rotation of the grinder motor.

10. The control system according to claim 1,
wherein the amount of ground coffee from the hopper during the grinding operation, is determined by the processor, over a grinding operation period; and
the processor is further configured to:
determine an accumulated amount value of ground coffee based on a plurality of determined amounts of ground coffee during the grinding operation, each determined amount of ground coffee being in relation to a respective grinding operation period.

11. The control system according to claim 8, wherein the processor is further configured to:
receive a user input relating to a desired amount of ground coffee;
discontinue the grinding operation when an accumulated amount value of ground coffee is determined to reach the desired amount of ground coffee.

12. The control system according to claim 10, wherein the processor is further configured to:
in response to determining that the load experienced by the grinder motor is variable, continue updating the accumulated amount value of ground coffee.

13. The control system according to claim 10, wherein the processor is further configured to:
in response to determining that the load experienced by the grinder motor is constant, discontinue the grinding operation and discontinue updating the accumulated amount value of ground coffee.

14. The control system of claim 13, wherein the processor is further configured to display, on an electric display device of the coffee grinder, that the hopper is empty or blocked in response to determining that the load experienced by the grinder motor is constant.

15. The control system according to claim 1, wherein the processor is further configured to:
determine the amount of ground coffee from the hopper during the grinding operation in response to at least one characteristic of the coffee beans in the hopper.

16. A coffee grinder comprising:
a hopper for containing coffee beans from which ground coffee can be dispensed;
a grinder motor for grinding the coffee beans contained in the hopper; and
the control system of claim 1 for determining an amount of ground coffee from the hopper during a grinding operation of the grinder motor, the control system being configured to control the grinder motor in response to a determined amount of ground coffee.
